(19) United States
(12) Patent Application Publication
(10) Pub. No.: US 2022/0239138 A1
(43) Pub. Date: Jul. 28, 2022

(54) Aquatic Energy Discharge System for an Energy Storage System of an Aircraft

(71) Applicant: LOON LLC, Mountain View, CA (US)

(72) Inventors: Kevin Anderson, Sunnyvale, CA (US); Samuel Truslow, San Francisco, CA (US)

(73) Assignee: LOON LLC, Mountain View, CA (US)

(21) Appl. No.: 17/155,736

(22) Filed: Jan. 22, 2021

(51) Int. Cl. H02J 7/00; B64D 45/00; B64D 41/00; H01M 10/44

(52) U.S. Cl. CPC H02J 7/007188; B64D 45/00; B64D 41/00; H01M 2220/20; H02J 7/0029; B64D 2041/005; H01M 10/44

(57) ABSTRACT

The technology relates to techniques for an aquatic energy discharge system for an energy storage system of an aircraft. An aquatic energy discharge system can include an energy storage system, a pair of electrodes coupled to the energy storage system, and a water detection system configured to detect a water landing. The electrodes can be configured to submerge in a body of water after the aircraft has landed in the body of water, and cause a hydrolysis reaction that drains energy from the energy storage system in response to the water detection system detecting the water landing. A method of discharging an energy storage system of an aircraft can include detecting that an aircraft (or portion thereof) has landed in a body of water, and discharging the energy storage system by powering a hydrolysis reaction using a pair of electrodes.

### BACKGROUND OF INVENTION

Aircraft typically rely on energy storage systems to power various electrical systems. The exceptionally low population density of water areas can be attractive landing locations for an aircraft at the end of a flight. One of the larger risks or safety hazards of landing an aircraft in water is the combination of high energy density energy storage systems, for example, a battery, with water. An energy storage system in contact with water can be a safety risk, for example, to a recovery crew tasked with recovering an aircraft after a water landing. Additionally, an energy storage system in contact with water can cause damage to the aircraft after a water landing, for example, due to fire caused by contact of a charged battery with water.

The safety risks of an energy storage system of a vehicle (e.g., an automobile, a watercraft, or an aircraft) coming into contact with water have been mitigated using conventional systems, for example, by reducing or blocking the output of a battery when the presence of water is detected. A sensor on the outside of a housing containing the battery is used to detect the presence of water. The sensor can output an electrical signal in response to being in contact with water, and the output of the battery can be reduced or blocked in response to the electrical signal. However, in such solutions the batteries are still charged and therefore the potential for an accident, such as an electrical shock or fire due to contact between the charged battery and water, is still possible. In some cases, an energy storage system can be waterproofed to protect the system from contact with water. However, waterproofing can be disadvantageous because such solutions can substantially increase the weight of the aircraft or lower the gravimetric energy density of the energy storage system.

### BRIEF SUMMARY

The present disclosure provides techniques for an aquatic energy discharge system for an energy storage system of an aircraft. An aquatic energy discharge system for an energy storage system of an aircraft can include: an energy storage system; a pair of electrodes coupled to the energy storage system; and a water detection system configured to detect a water landing, wherein the electrodes are configured to submerge in a body of water after the aircraft has landed in the body of water, and wherein the electrodes are configured to cause a hydrolysis reaction that drains energy from the energy storage system in response to the water detection system detecting the water landing. In an example, the water detection system comprises a water contact sensor configured to detect contact between the energy discharge system and water. In another example, the water detection system comprises an accelerometer or a shock sensor configured to detect the water landing. In another example, the water detection system comprises a passive system comprising a dissolvable plug, wherein the dissolvable plug is configured to isolate the pair of electrodes from the body of water before dissolving, and wherein the dissolvable plug is configured to expose the pair of electrodes to the body of water after dissolving. In another example, the dissolvable plug comprises a salt or a polymer. In another example, the energy storage system comprises a battery or a fuel cell. In another example, the body of water is an ocean, lake, pond, reservoir, river, or stream. In another example, the electrodes are configured to deliver energy to the body of water to cause the hydrolysis reaction.

A method of discharging an energy storage system of an aircraft can include: detecting that an aircraft or a portion of an aircraft has landed in a body of water using a water detection system; and discharging an energy storage system of the aircraft or portion of the aircraft, in response to the water detection system detecting that the aircraft or portion of the aircraft has landed in the body of water, by powering a hydrolysis reaction using a pair of electrodes, wherein the electrodes are coupled to the energy storage system and are submerged in the body of water. In an example, the detecting that the aircraft or portion of the aircraft has landed in the body of water using the water detection system comprises using a water contact sensor that detects the presence of the body of water, and wherein the discharging the energy storage system of the aircraft or portion of the aircraft further comprises energizing the pair of electrodes to power the hydrolysis reaction in response to the active sensor detecting presence of the body of water. In another example, the detecting that the aircraft or portion of the aircraft has landed in the body of water using the water detection system comprises using an accelerometer or a shock sensor, and wherein the discharging the energy storage system of the aircraft or portion of the aircraft further comprises energizing the pair of electrodes to power the hydrolysis reaction in response to the accelerometer or the shock sensor detecting that the aircraft or portion of the aircraft has landed in the body of water. In another example, detecting that the aircraft or portion of the aircraft has landed in the body of water using the water detection system comprises using a passive water detection system comprising dissolving the dissolvable plug by the body of water, wherein the pair of electrodes are isolated from the body of water by the dissolvable plug before the dissolvable plug is dissolved, and wherein the electrodes are submerged in the body of water after the dissolvable plug is dissolved by the body of water. In another example, the discharging the energy storage system comprises using a controller electrically coupled to the pair of electrodes and to the energy storage system to energize the pair of electrodes and control the hydrolysis reaction. In another example, the powering the hydrolysis reaction using the pair of electrodes further comprises controlling, using the controller, a voltage applied to the electrodes, including one or both of a magnitude and a duration of the applied voltage. In another example, the powering the hydrolysis reaction using the pair of electrodes further comprises controlling, using the controller, a current applied to the electrodes, including one or both of a magnitude and a duration of the applied current. In another example, the powering the hydrolysis reaction using the pair of electrodes further comprises controlling, using the controller, a total amount of charge drained from the energy storage system. In another example, the discharging the energy storage system is initiated within 2 minutes from a time when the aircraft makes contact with the body of water. In another example, the energy storage system comprises a battery or a fuel cell. In another example, the body of water comprises an ocean, a lake, a pond, a reservoir, a river, a stream, or portion thereof.

### BRIEF DESCRIPTION OF THE DRAWINGS

FIG. 1A is a simplified schematic in side view of an example of a portion of an aircraft containing an aquatic EDS, in accordance with some embodiments.

FIG. 1B is a simplified schematic in side view of another example of a portion of an aircraft containing an aquatic EDS, in accordance with some embodiments.

FIGS. 2A and 2B are simplified schematics in side view of an example of a portion of an aircraft containing an aquatic EDS, in accordance with some embodiments.

FIGS. 3A-3B are diagrams of example aircraft systems that are LTA vehicle systems incorporating aquatic EDSs, in accordance with some embodiments.

FIG. 4A shows a simplified schematic of an example of an unmanned aerial vehicle (UAV) incorporating the present aquatic EDS, in accordance with some embodiments.

FIG. 4B shows a simplified schematic of an example of fixed wing aerial vehicle incorporating the present aquatic EDS, in accordance with some embodiments.

FIG. 4C shows a simplified schematic of an example of an aerospace vehicle (or portion thereof) incorporating an aquatic EDS, in accordance with some embodiments.

FIG. 5 is a simplified block diagram of an example of a computing system forming part of the systems of FIGS. 3A-3B and 4A-4C, in accordance with some embodiments.

FIG. 6 is a flow diagram illustrating a method for discharging an energy storage system of an aircraft, in accordance with some embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The invention is directed to an aquatic energy discharge system (EDS) for an energy storage system of an aircraft. The exceptionally low population density of water areas can be attractive landing locations for an aircraft at the end of a flight (e.g., when it experiences a problem, or has reached the end of its useful service life). One of the larger risks or safety hazards of landing an aircraft in a watery area is the combination of high energy density energy storage systems (e.g., containing a battery, a fuel cell, or other energy storage technology) with water (e.g., electrically conductive seawater or other ionized water). It is advantageous, or in some cases necessary, for aircraft to maintain power as they fly all the way back to the ground, so draining the energy storage system (e.g., batteries) prior to the end of the flight may be disadvantageous, or may not be a viable option. The present systems and methods provide a way to quickly discharge an energy storage system of an aircraft upon landing in water to make it safer for prolonged contact with water. For example, discharging batteries of an aircraft (e.g., an LTA vehicle) in a controlled manner using an aquatic EDS can prevent a charged battery from being unsafe (e.g., being an electrical shock hazard and/or a fire hazard) and/or causing damage to the aircraft (e.g., a mechanical or electrical system of the aircraft) after a water landing by reducing the risk of fire caused by contact of a charged battery with water.

The aquatic EDSs and methods described herein provide ways to safely discharge an energy storage system (e.g., batteries or fuel cells) of an aircraft in case of a water landing due to a planned or an unplanned event. In the event of a water landing, the aircraft, or a portion of the aircraft containing the energy storage system, lands in a body of water (e.g., an ocean, lake, pond, reservoir, river, stream, or other body of water). In some cases, the EDS actively detects contact between an aircraft (or portion thereof) and a body of water, for example, using a sensor. In other cases, the EDS detects the presence of a body of water by passively responding to contact between an aircraft (or portion thereof) and a body of water, for example, using an element that will dissolve on contact with water. After an aircraft (or portion thereof) has landed in water, and optionally after the water is detected using the active or passive water detection system, a discharge device (e.g., containing a pair of electrodes) can be exposed to the water. After the discharge devices are exposed to water, and optionally after the water is detected using the active or passive water detection system, the discharge device can be energized (e.g., in a controlled manner). The energized discharge device (e.g., electrodes) can then be used to deplete the remaining energy of the energy storage system by powering a hydrolysis reaction to hydrolyze the water from the body of water (i.e., using the energy in the energy storage system to convert the water into hydrogen and oxygen).

In some cases, a discharge device of the aquatic EDSs described herein may comprise two electrodes that are coupled to an energy storage system of the aircraft. The discharge device can deliver energy to the water to perform the hydrolysis reaction, whereby energy is drained from the energy storage system. The hydrolysis reaction can drain all (or most) of the energy stored in the energy storage system, such that it is safer for a recovery crew to recover the aircraft or portion thereof (e.g., a payload of an aircraft) containing the safely discharged energy storage system (e.g., discharged batteries). In some cases, the energy storage system can be electrically coupled to a computing system (or controller, or processor), the computing system can be electrically coupled to the discharge device (e.g., containing two electrodes), and the computing system can control the hydrolysis reaction. For example, the computing system can control the energizing of the discharge device, the magnitude of voltage and current applied to the discharge device, the duration of the voltage and current applied to the discharge device, and the total amount of charge drained from the energy storage system.

The aquatic EDSs described herein can be used in any type of aircraft that may experience a rapid change in state from being airborne to the aircraft (or a portion thereof) being fully or partially submerged in water (e.g., due to a planned or unplanned water landing). The present systems and methods can be applied to various types of aerial vehicles, which could benefit from an aquatic EDS to improve the safety of the vehicle after a (planned or unplanned) water landing. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive LTA vehicles (e.g., floating stratospheric balloons, other floating or wind-driven vehicles), powered LTA vehicles (e.g., balloons and airships with some propulsion capabilities), fixed-wing vehicles (e.g., drones, rigid kites, gliders), various types of aerospace vehicles, satellites, rockets, space stations, and other high altitude aerial vehicles.

In some cases, the recovery crew may locate the aircraft (or a portion of the aircraft, such as a payload) by following a signal from a location beacon coupled to the aircraft (or portion thereof). The location beacon can use any communication system to send a signal, for example, using a Global Positioning System (GPS), satellite communication system, LTE network, fixed wireless broadband via a 5G network, an Internet of Things (IoT) network, a free space optical network, or other broadband networks. In some cases, the location beacon may be powered by the energy storage system being discharged and may operate until the energy storage system is drained. In other cases, the location beacon may be separately powered (e.g., by a low power battery local to the location beacon or otherwise separately located from the energy storage system being discharged). In some cases, the location beacon is configured to start sending a signal upon contact with water, for example, using a water contact sensor coupled to the location beacon. The discharged recovered energy storage system (e.g., batteries) are then ready for recycling or repurposing.

In some cases, the active sensors of the present aquatic EDSs can be water contact sensors, such as those that change conductivity upon contact with water (i.e., the body of water in which the aircraft has landed). In other cases, an active sensor of the present aquatic EDSs can detect the shock experienced by the aircraft upon landing, and characterize the parameters of the shock to determine if the aircraft landed in the water or on land. In such cases, the active sensor can be an accelerometer or a shock sensor. In some cases, electrodes of the aquatic EDS are exposed such that they make contact with the body of water upon a water landing, and the electrodes are not energized to power the hydrolysis reaction until an active sensor detects the presence of water due to the water landing (or detects that the aircraft has landed in the water, e.g., using shock measurements). In some cases, electrodes of the aquatic EDS are hidden such that they do not make contact with the body of water until an active sensor detects the presence of water due to the water landing (or detects that the aircraft has landed in the water, e.g., using shock measurements). In such cases, the electrodes can be deployed (e.g., from a payload of the aircraft), thereby making contact with the water, in response to the detection of a water landing. After deployment, then the electrodes can be energized to power the hydrolysis reaction.

In some cases, the electrodes of the aquatic EDS are protected behind a passive water detection system upon landing in water, such as being isolated from the water by one or more plugs (e.g., made of salt) that dissolve due to contact with the body of water. The electrodes may be configured to become submerged in the water in response to a passive water detection system detecting a water landing (e.g., by the water sufficiently dissolving a plug, thereby allowing water to contact the electrodes). In some cases, an aircraft (or portion thereof) can contain a passive water detection system (e.g., containing a dissolvable plug) and also an active water detection system (e.g., a water contact sensor). For example, the water contact sensor can be placed behind the dissolvable plug in a region adjacent to the electrodes. In such cases, after the dissolvable plug passively detects the presence of water (by dissolving) the water contact sensor actively detects the presence of water and confirms that the electrodes are exposed to the water before the electrodes are energized to power the hydrolysis reaction.

In some cases, an active or passive system can detect the presence of water and can initiate the hydrolysis reaction in less than 2 seconds, in less than 20 seconds, in less than 1 minute, or in less than 2 minutes from a time when the aircraft makes contact with a body of water. In some cases, exposure to rain is not sufficient to trigger the system to detect the presence of water due to a water landing. For example, the aircraft may land on ground or other surface that is not water (i.e., a non-water landing) and become wet from rain, and the water detection system does not detect the presence of water that would trigger the beginning of the hydrolysis reaction. This can be accomplished, for example, by placing the active or passive sensor in a location (e.g., on a lower portion of the payload) that will enable the sensor to detect the presence of a body of water after a water landing and prevent the sensor from falsely detecting a water landing (e.g., in the case of rain after a non-water landing). The persistence of the water may also be used to detect water due to a water landing. For example, a plug can be configured to dissolve away only after persistent contact with (or submersion in) water for a sufficient amount of time (e.g., less than 1 minute, or less than 2 minutes), or an active sensor may be programmed to detect a water landing after submersion in, or persistent contact with, water for a given period of time (e.g., less than 2 seconds, less than 20 seconds, less than 1 minute, or less than 2 minutes). In some cases, the aircraft lands in a muddy or marshy region, and the EDS determines if there is sufficient liquid water present to drain an energy storage system using hydrolysis reactions.

The aquatic EDSs described herein can power electrolysis reactions to discharge energy storage systems with different electrical parameters. For example, the energy storage system can have an operating voltage from 10 V to 100 V, or from 38 V to 50 V, or less than 10 V, or greater than 100 V, in different cases. The minimum voltage that can be used by the aquatic EDS to power the electrolysis reaction is determined by the minimum voltage needed for electrolysis of water, which is greater than about 1.2 V in some cases. In some examples, the total charge discharged from the energy storage system can be from 1 kWh to 10 kWh, or from 4 kWh to 6 kWh, or less than 1 kWh, or greater than 10 kWh. The total time of discharge is inversely related to the discharge current (i.e., the current delivered to the electrodes from the energy storage system to power the electrolysis reaction). For example, if the discharge current is 10 A then 5 kWh could be discharged in about 10 hours from an energy storage system with about 50 V operating voltage. If the discharge current is reduced by half to 5 A then 5 kWh could be discharged from the energy storage system in about 20 hours. The discharge current can be from 1 A to 20 A, or from 5 A to 10 A, or less than 1 A, or greater than 20 A, in different cases. The discharge time can be from 1 hour to 24 hours, or from 5 hours to 10 hours, or less than 1 hour, or greater than 24 hours, in different cases. The electrical parameters used by the aquatic EDS can change due to different factors and constraints. For example, some factors that can affect the electrical parameters used are the rate at which the energy storage system is to be discharged, the electrical specifications of the energy storage system (e.g., the output voltage range, the output current range, and the total charge capacity), and the electrical specifications of other components of the aquatic EDS (e.g., the current capacity of the electrodes and the wires coupling the electrodes to the energy storage system).

The electrodes of the aquatic EDSs described herein can be made from any suitable electrically conductive material, such as steel, iron, nickel-iron, or precious metals, e.g., Ag, Au, Pt, Ir. The electrodes can be homogeneous (e.g., solid metal) or can be coated with a conductive material (e.g., plated with Au or Ag), in different embodiments.

The aquatic EDS can be autonomous, manually controlled, or both. For example, the EDS can automatically detect the presence of water and power the hydrolysis reaction to drain energy from the energy storage system. In another example, the EDS can automatically detect the presence of water, but powering the hydrolysis reaction to drain energy from the energy storage system can be triggered manually (e.g., by an operator that can communicate with the aircraft (or portion thereof)). In some cases, the aircraft (or portion thereof) contains an onboard computing system that controls the EDS. In some cases, the aircraft (or portion thereof) also contains a communications system, wherein the onboard computing system is in communication with an offboard system through the communications system. The onboard computing system can control autonomous operation of the EDS, while manual control commands can be sent from the offboard system (e.g., controlled by an operator) to the onboard computing system to manually control the EDS.

In some cases, the EDSs described herein contain a dissolvable plug. The dissolvable plug may be made from any material that will dissolve due to the presence of a body of water after a water landing. For example, the dissolvable plug can be made from a salt, a dehydrated salt, a polymer, polyglycolic acid, polylactic acid, a dissolvable metal, galvanically-corrodible metals, and any combination thereof.

Example Systems

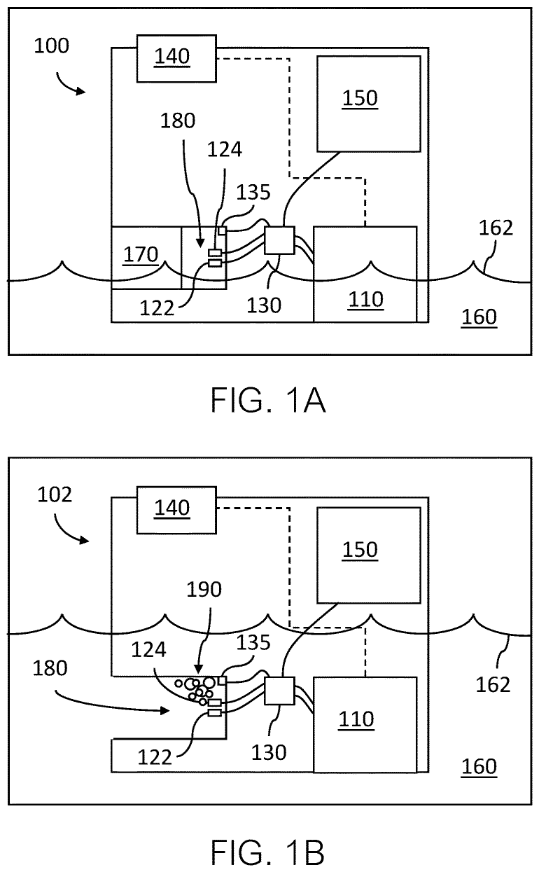

FIG. 1A is a simplified schematic in side view of an example of a portion of an aircraft containing an aquatic EDS. In some cases, after a water landing the aircraft will be substantially intact. In other cases, a portion of the aircraft can be separated from the rest of the aircraft before or at the time of landing (e.g., due to impact with the ground or water). Element 100 is a portion of an aircraft, which may be coupled to additional portions of the aircraft (not shown). The portion of the aircraft 100 contains an energy storage system 110, electrodes 122 and 124, a location beacon system 140, and subsystem 150. The electrodes 122 and 124 are electrically coupled to the energy storage system 110. Optionally, the electrodes 122 and 124 are electrically coupled to the energy storage system 110 through electrical couplings to a controller 130. In other cases, the electrodes 122 and 124 can be electrically coupled directly to the energy storage system 110. In some cases, system 150 is also electrically coupled to controller 130, such that sensors in system 150 can send signals to the controller 130. The portion of the aircraft 100 is partially submerged in water 160 having a surface 162. The location beacon system 140 may send out a signal after the vehicle (or portion thereof 100) has landed in order for a recovery crew to locate the vehicle (or portion thereof 100). The location beacon system 140 may be powered by the energy storage system 110 (e.g., shown by dashed line in FIG. 1A) or it may be separately powered (e.g., by a low power battery (not shown) local to the location beacon or otherwise separately located from the energy storage system being discharged). In some cases, the location beacon system 140 could be coupled to the controller 130 (not shown), be powered by energy storage system 110, and be controlled using controller 130. The subsystem 150 can contain sensors, such as accelerometers and shock sensors, in some cases.

The portion of the aircraft 100 also contains a dissolvable plug 170 that has not yet been dissolved by water 160. Plug 170 isolates the electrodes 122 and 124 from water 160, and other water that may come in contact with an outer surface of aircraft/payload 100. The dissolvable plug 170, along with one or more other surfaces of aircraft/payload 100, defines a space 180 (e.g., a cavity) that is not open to the water 160 (i.e., does not contain water or other solvent or liquid able to dissolve dissolvable plug 170). Electrodes 122 and 124 may be contained in the space 180 isolated from the water 160 before the dissolvable plug 170 is dissolved. In some cases, the portion of the aircraft 100 can contain more than one dissolvable plug. For example, there can be two dissolvable plugs, one isolating each electrode 122 and 124 from the water 160 and there can be a separate space similar to 180 for each electrode. The portion of the aircraft also optionally contains a water contact sensor 135 electrically coupled to controller 130. In some cases, the portion of the aircraft 100 can be coupled to additional portions of the aircraft (not shown) after landing in the water 160.

FIG. 1B is a simplified schematic in side view of another example of a portion of an aircraft containing an aquatic EDS. Like-numbered elements in FIG. 1B are the same as those described above with respect to FIG. 1A. In some cases, after a water landing the aircraft will be substantially intact, and portion of the aircraft 102 can be coupled to the rest of the aircraft (not shown), or to additional portions of the aircraft (not shown).

In some cases, the portion of the aircraft 102 is the same portion of the aircraft 100 in FIG. 1A shown after the dissolvable plug 170 has dissolved. In this case, space 180 is open to the water 160 and the electrodes 122 and 124 make contact with the water 160. After the electrodes 122 and 124 make contact with water, a hydrolysis reaction can proceed, which generates gases 190 (i.e., hydrogen and oxygen gas). In cases where controller 130 is omitted and the electrodes 122 and 124 are coupled directly to the energy storage system 110, the hydrolysis reaction begins upon contact with water. In some cases, after the dissolvable plug 170 is dissolved and the electrodes 122 and 124 are in contact with water 160, the controller 130 energizes the electrodes 122 and 124 to power a hydrolysis reaction causing energy from the energy storage system 110 to be drained. For example, controller 130 can be used to control the hydrolysis reaction by controlling the electrical current, voltage and duration of the electrical power provided from the energy storage system 110 to the electrodes 122 and 124. In some cases, after the dissolvable plug 170 is dissolved, then the water contact sensor 135 sends a signal to the controller 130 that the electrodes 122 and 124 are exposed to the water, and the controller 130 can energize the electrodes 122 and 124 in response to the signal. In some cases, after the dissolvable plug 170 is dissolved, then an accelerometer or shock sensor in subsystem 150 sends a signal to the controller 130 that a water landing has occurred, and the controller 130 can energize the electrodes 122 and 124 in response to the signal.

In some cases, FIG. 1B shows a portion of an aircraft 102 directly after landing in water 160, wherein the portion of aircraft 102 never contained a dissolvable plug. In these cases, the electrodes 122 and 124 are exposed and make contact with the water 160 upon a water landing. In such cases, controller 130 can be used to energize the electrodes 122 and 124 to power the hydrolysis reaction and allow energy from the energy storage system 110 to be drained. For example, controller 130 can receive an indication from a water contact sensor 135 that the electrodes 122 and 124 are in contact with water, and then the controller 130 can energize the electrodes 122 and 124 in response to the indication. In other cases, subsystem 150 can contain an accelerometer or a shock sensor and controller 130 can receive an indication from the accelerometer or shock sensor that the portion of the aircraft 102 has made a water landing, and then the controller 130 can energize the electrodes 122 and 124 in response to the indication. Controller 130 can be used to control the hydrolysis reaction, for example, by controlling the electrical current, voltage and duration of the electrical power provided from the energy storage system 110 to the electrodes 122 and 124.

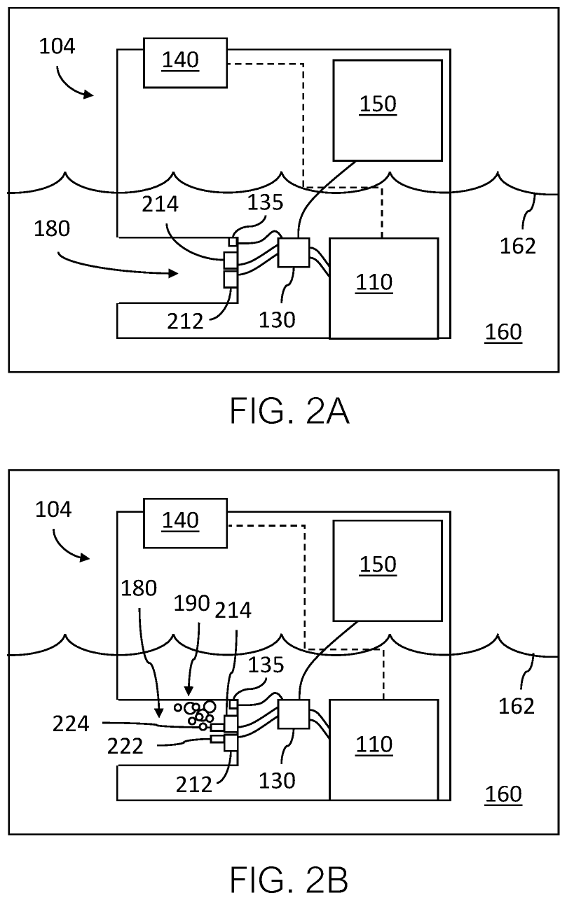

FIGS. 2A and 2B are simplified schematics in side view of an example of a portion of an aircraft containing an aquatic EDS. Like-numbered elements in FIGS. 2A and 2B are the same as those described above with respect to FIGS. 1A and 1B. FIG. 2A shows an example where the portion of the aircraft 104 does not contain a passive water detection system (e.g., a dissolvable plug) and where the electrodes are not exposed upon landing in the water 160. In some cases, after a water landing the aircraft will be substantially intact, and portion of the aircraft 104 can be coupled to the rest of the aircraft (not shown), or to additional portions of the aircraft (not shown). The electrodes in this example are isolated from water 160 in space 180 by being contained within housings 212 and 214. FIG. 2B shows the electrodes 222 and 224 after they have been deployed from housings 212 and 214. For example, the electrodes 222 and 224 can be deployed from housings 212 and 214 in response to controller 130 receiving an indication from water contact sensor 135 that it is in contact with water. Alternatively, the electrodes 222 and 224 can be deployed from housings 212 and 214 in response to controller 130 receiving an indication from an accelerometer or shock sensor in subsystem 150 that a water landing has occurred. In some cases, the electrodes (e.g., 222 and 224) can be deployed from housings (e.g., 212 and 214) using a spring-loaded mechanism (not shown). For example, housings 212 and 214 can each have a cover (not shown) isolating electrodes 222 and 224 from water 160 in space 180, and electrodes 222 and 224 can each be deployed around or through the covers in housings 212 and 214, respectively. For example, the covers can be pushed aside or break (e.g., from the force of the spring-loaded mechanism) and the electrodes can deploy from the housings with the cover out of the way. In another example, the covers can each contain a slit (e.g., made of rubber) that can be sealed to isolate an electrode (e.g., 222 or 224) from water, and the slit can deform and permit an electrode to deploy through the slit due to the force from the spring-loaded mechanism.

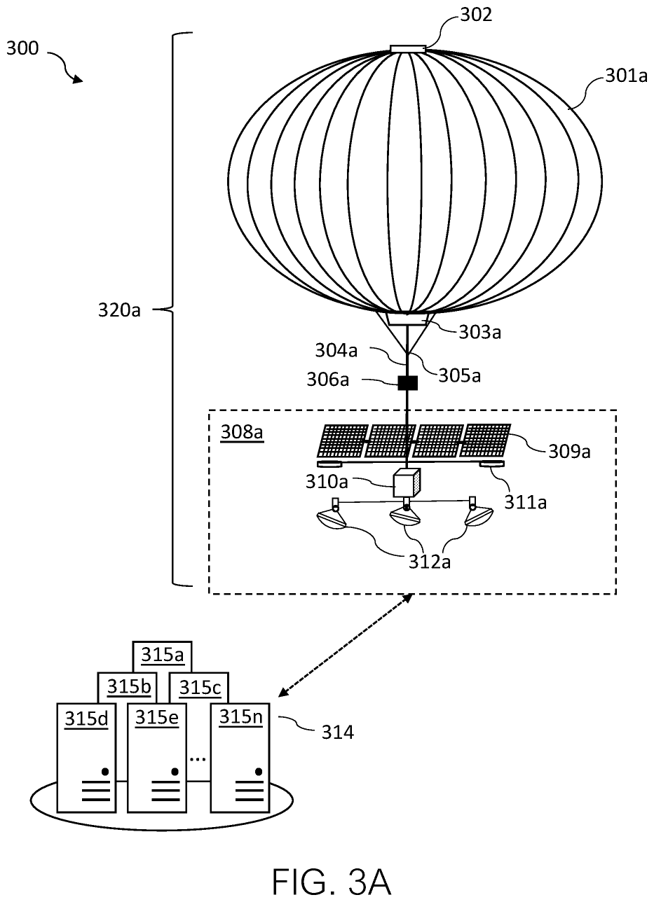

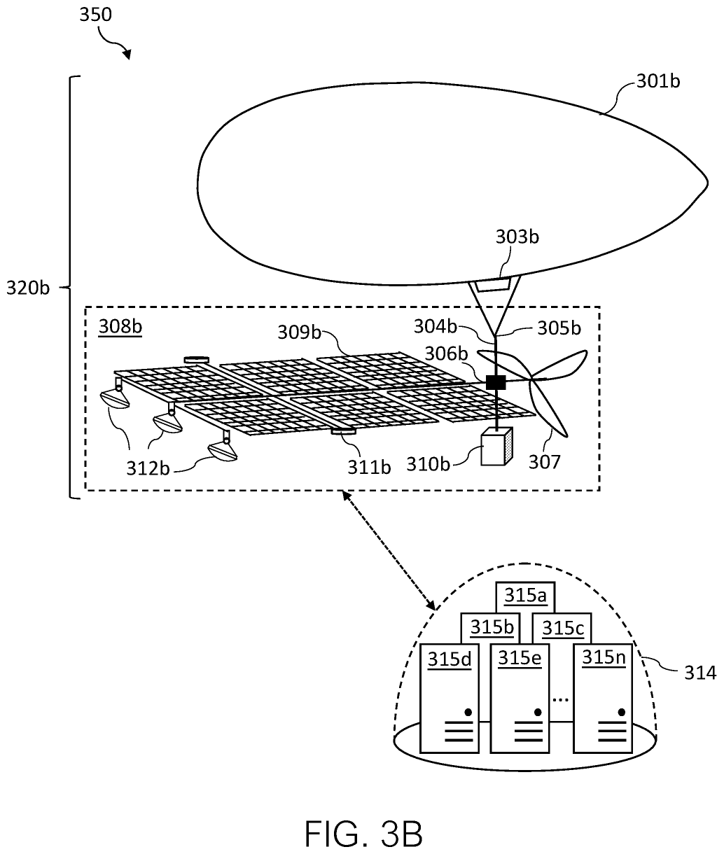

FIGS. 3A-3B are diagrams of example aircraft systems that are LTA vehicle systems incorporating aquatic EDSs, in accordance with some embodiments. The LTA vehicles 320a-b shown in FIGS. 3A-3B, and described further below, contain EDSs to drain energy from an energy storage system of the LTA vehicle after a water landing, as described above.

In FIG. 3A, there is shown a diagram of system 300 for control and navigation of LTA vehicle 320a. In some examples, LTA vehicle 320a may be a passive vehicle, such as a balloon or satellite (not shown), wherein most of its directional movement is a result of environmental forces, such as wind and gravity. In other examples, LTA vehicles 320a may be actively propelled. In an embodiment, system 300 may include LTA vehicle 320a and ground station 314. In this embodiment, LTA vehicle 320a may include balloon 301a, plate 302, altitude control system (ACS) 303a, connection 304a, joint 305a, actuation module 306a, and payload 308a. In some examples, plate 302 may provide structural and electrical connections and infrastructure. Plate 302 may be positioned at the apex of balloon 301a and may serve to couple together various parts of balloon 301a. In other examples, plate 302 also may include a flight termination unit (e.g., that is a part of a flight termination system (FTS)), such as one or more blades and an actuator to selectively cut a portion and/or a layer of balloon 301a. ACS 303a may include structural and electrical connections and infrastructure, including components (e.g., fans, valves, actuators, etc.) used to, for example, add and remove air from balloon 301a (i.e., in some examples, balloon 301a may include an interior ballonet within its outer, more rigid shell that is inflated and deflated), causing balloon 301a to ascend or descend, for example, to catch stratospheric winds to move in a desired direction. Balloon 301a may comprise a balloon envelope comprised of lightweight and/or flexible latex or rubber materials (e.g., polyethylene, polyethylene terephthalate, chloroprene), tendons (e.g., attached at one end to plate 302 and at another end to ACS 303a) to provide strength to the balloon structure, a ballonet, along with other structural components. In various embodiments, balloon 301a may be non-rigid, semi-rigid, or rigid.

Connection (i.e., down-connect) 304a may structurally, electrically, and communicatively, connect balloon 301a and/or ACS 303a to various components comprising payload 308a. In some examples, connection 304a may provide two-way communication and electrical connections, and even two-way power connections. Connection 304a may include a joint 305a, configured to allow the portion above joint 305a to pivot about one or more axes (e.g., allowing either balloon 301a or payload 308a to tilt and turn). Actuation module 306a may provide a means to actively turn payload 308a for various purposes, such as improved aerodynamics, facing or tilting solar panel(s) 309a advantageously, directing payload 308a and propulsion units (e.g., propellers 307 in FIG. 3B) for propelled flight, or directing components of payload 308a advantageously. In some cases, the down-connect 304a is configured to separate at a separation point causing the payload 308a and the balloon 301a to separate from one another (e.g., due to triggering by an FTS). In such cases, the down-connect can also include a parachute (not shown) that can be deployed to slow the descent of the payload 308a after separation.

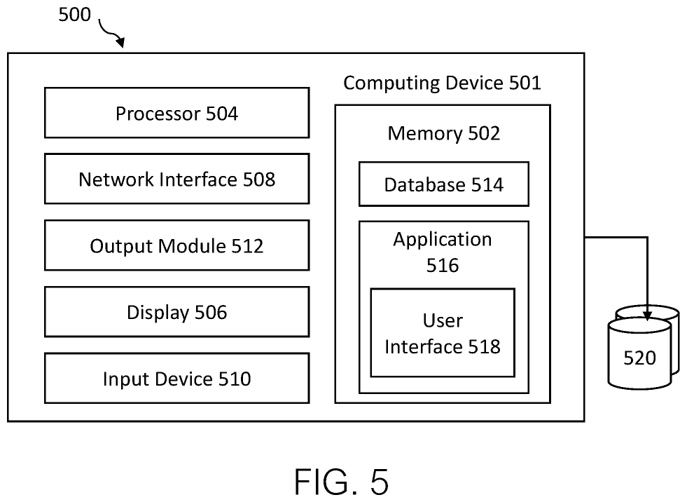

Payload 308a may include solar panel(s) 309a, avionics chassis 310a, broadband communications unit(s) 311a, and terminal(s) 312a. Solar panel(s) 309a may be configured to capture solar energy to be provided to a battery or other energy storage system (e.g., containing a battery, a fuel cell, or other energy storage technology), for example, housed within avionics chassis 310a. Avionics chassis 310a can be the portion of the aircraft 100 in FIG. 1A, 102 in FIG. 1B, or 104 in FIGS. 2A and 2B. The energy storage system can be discharged using the aquatic EDSs described herein, after LTA vehicle 320a experiences a water landing. Avionics chassis 310a also may house a flight computer (e.g., to electronically control various systems within the LTA vehicle 320a, such as computing device 501 in FIG. 5), a transponder, along with other control and communications infrastructure (e.g., a computing device and/or logic circuit configured to control LTA vehicle 320a). In some cases, the flight computer controls the aquatic EDS (e.g., the flight computer can be controller 130 in FIGS. 1A-2B). Communications unit(s) 311a may include hardware to provide wireless network access (e.g., LTE, fixed wireless broadband via 5G, Internet of Things (IoT) network, free space optical network or other broadband networks). Terminal(s) 312a may comprise one or more parabolic reflectors (e.g., dishes) coupled to an antenna and a gimbal or pivot mechanism (e.g., including an actuator comprising a motor). Terminal(s) 312(a) may be configured to receive or transmit radio waves to beam data long distances (e.g., using the millimeter wave spectrum or higher frequency radio signals). In some examples, terminal(s) 312a may have very high bandwidth capabilities. Terminal(s) 312a also may be configured to have a large range of pivot motion for precise pointing performance. Terminal(s) 312a also may be made of lightweight materials.

In other examples, payload 308a may include fewer or more components, including propellers 307 as shown in FIG. 3B, which may be configured to propel LTA vehicles 320a-b in a given direction. In still other examples, payload 308a may include still other components well known in the art to be beneficial to flight capabilities of an LTA vehicle. For example, payload 308a also may include energy capturing units apart from solar panel(s) 309a (e.g., rotors or other blades (not shown) configured to be spun by wind to generate energy). In another example, payload 308a may further include or be coupled to an imaging device (e.g., a star tracker, IR, video, Lidar, and other imaging devices, for example, to provide image-related state data of a balloon envelope, airship hull, and other parts of an LTA vehicle). In another example, payload 308a also may include various sensors (not shown), for example, housed within avionics chassis 310a or otherwise coupled to connection 304a or balloon 301a. Such sensors may include a water contact sensor (e.g., 135 in FIGS. 1A-2B), accelerometers and shock sensors that can be used by the aquatic EDS. Payload 308a may also include other sensors, such as Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure. Payload 308a can also contain a passive water detection system (e.g., using a dissolving plug), as described herein.

Ground station 314 may include one or more server computing devices 315a-n, which in turn may comprise one or more computing devices (e.g., a computing device and/or logic circuit configured to control LTA vehicle 320a). In some examples, ground station 314 also may include one or more storage systems, either housed within server computing devices 315a-n, or separately. Ground station 314 may be a datacenter servicing various nodes of one or more networks.

FIG. 3B shows a diagram of system 350 for control and navigation of LTA vehicle 320b. All like-numbered elements in FIG. 3B are the same or similar to their corresponding elements in FIG. 3A, as described above (e.g., balloon 301a and balloon 301b may serve the same function, and may operate the same as, or similar to, each other). In some examples, balloon 301b may comprise an airship hull or dirigible balloon. In this embodiment, LTA vehicle 320b further includes, as part of payload 308b, propellers 307, which may be configured to actively propel LTA vehicle 320b in a desired direction, either with or against a wind force to speed up, slow down, or re-direct, LTA vehicle 320b. In this embodiment, balloon 301b also may be shaped differently from balloon 301a, to provide different aerodynamic properties.

As shown in FIGS. 3A-3B, LTA vehicles 320a-b may be largely wind-influenced LTA vehicle, for example, balloons carrying a payload (with or without propulsion capabilities) as shown, or fixed wing high altitude drones (not shown) with gliding and/or full propulsion capabilities. However, those skilled in the art will recognize that the systems disclosed herein may similarly apply and be usable by various other types of LTA vehicles.

In some cases, an aerial vehicle with an aquatic EDS, as described herein, does not include a balloon and the required lift is provided by other means. For example, aerial vehicles with propellers, high altitude aerial vehicles with propellers, and/or gliders with no propellers can all benefit from the present systems.

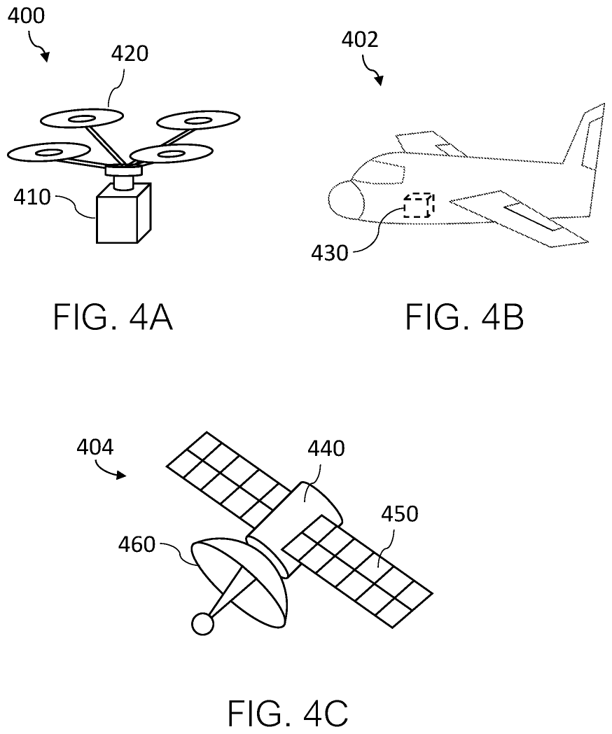

FIG. 4A shows a simplified schematic of an example of an unmanned aerial vehicle (UAV) 400 incorporating the present aquatic EDS, in accordance with some embodiments. The UAV 400 depicts a UAV containing an avionics chassis 410 and four propellers 420 that provide lift. In other UAV examples, there can be more or fewer than four propellers. Avionics chassis 410 can comprise the portion of the aircraft 100 in FIG. 1A, 102 in FIG. 1B, or 104 in FIGS. 2A and 2B. The UAV 400 can also contain an energy storage system (e.g., containing batteries, fuel cells, or other energy storage system technologies) to power the propellers 420 and the other systems of the UAV 400. The UAV 400 can also contain sensors (not shown), such as water contact sensors, accelerometers and shock sensors that can be used by the EDS, as well as other sensors such as temperature sensors, barometric pressure sensors, wind speed sensors, wind direction sensors, global positioning system (GPS) components, and image sensors. The UAV 400 can also contain passive water detection systems (e.g., using a dissolving plug), as describe herein. The UAV 400 contains an aquatic EDS to drain energy from an energy storage system of the UAV 400 after a water landing, as described above.

FIG. 4B shows a simplified schematic of an example of fixed wing aerial vehicle 402 incorporating the present aquatic EDS, in accordance with some embodiments. The fixed wing aerial vehicle 402 can be a glider, or a powered vehicle with a propeller (not shown) or jet engines (not shown), and contains a portion of the aircraft 430. The portion of the aircraft 430 can be the portion of the aircraft 100 in FIG. 1A, 102 in FIG. 1B, or 104 in FIGS. 2A and 2B. The portion of the aircraft 430 can also contain an energy storage system (e.g., containing batteries, fuel cells, or other energy storage system technologies) to power the systems of the fixed wing aerial vehicle 402. The portion of the aircraft 430 can also contain sensors (not shown), such as water contact sensors, accelerometers and shock sensors that can be used by the EDS, as well as other sensors such as temperature sensors, barometric pressure sensors, wind speed sensors, wind direction sensors, global positioning system (GPS) components, and image sensors. The portion of the aircraft 430 can also contain passive water detection systems (e.g., using a dissolving plug), as describe herein. The portion of the aircraft 430 contains an aquatic EDS to drain energy from an energy storage system of the fixed wing aerial vehicle 402 after a water landing, as described above.

FIG. 4C shows a simplified schematic of an example of an aerospace vehicle (or portion thereof) 404 (e.g., a satellite, rocket, or space station) incorporating an aquatic EDS, as described herein. The aerospace vehicle 404 contains a portion of the vehicle 440, as well as optional solar panels 450 and an optional communication system 460. However, other aerospace vehicles can contain different components (e.g., omitting solar panels 450 and communication system 460) without changing the functioning of the aquatic EDSs described herein. The portion of the vehicle 440 can be the portion of the aircraft 100 in FIG. 1A, 102 in FIG. 1B, or 104 in FIGS. 2A and 2B. The portion of the aerospace vehicle 440 can also contain an energy storage system (e.g., containing batteries, fuel cells, or other energy storage system technologies) to power the systems of the vehicle 404. The portion of the aerospace vehicle 440 can also contain sensors (not shown), such as water contact sensors, accelerometers and shock sensors that can be used by the EDS, as well as other sensors such as temperature sensors, barometric pressure sensors, wind speed sensors, wind direction sensors, global positioning system (GPS) components, and image sensors. The portion of the aerospace vehicle 440 can also contain passive water detection systems (e.g., using a dissolving plug), as describe herein. The portion of the aerospace vehicle 440 contains an aquatic EDS to drain energy from an energy storage system of the vehicle 404 after a water landing, as described above.

FIG. 5 is a simplified block diagram of an example of a computing system forming part of the systems of FIGS. 3A-3B and 4A-4C, in accordance with one or more embodiments. Any reference to a computer (e.g., flight computer, server, controller, processor, etc.) herein may be implemented using the computing system 500 in FIG. 5. In some cases, the computing system 500 is or contains the controller (e.g., 130 in FIGS. 1A-2B) that can control the EDSs described herein. In one embodiment, computing system 500 may include computing device 501 and storage system 520. Storage system 520 may comprise a plurality of repositories and/or other forms of data storage, and it also may be in communication with computing device 501. In another embodiment, storage system 520, which may comprise a plurality of repositories, may be housed in one or more of computing device 501 (not shown). In some examples, storage system 520 may store state data, commands, flight policies, and other various types of information (e.g., pressure measurements, thresholds and offsets) as described herein. This information may be retrieved or otherwise accessed by one or more computing devices, such as computing device 501 or server computing devices 510 in FIG. 5, in order to perform some or all of the features described herein. Storage system 520 may comprise any type of computer storage, such as a hard-drive, memory card, ROM, RAM, DVD, CD-ROM, write-capable, and read-only memories. In addition, storage system 520 may include a distributed storage system where data is stored on a plurality of different storage devices, which may be physically located at the same or different geographic locations (e.g., in a ground station (e.g., 315 in FIGS. 3A-3B), or in a distributed computing system (not shown)). Storage system 520 may be networked to computing device 501 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Example Methods

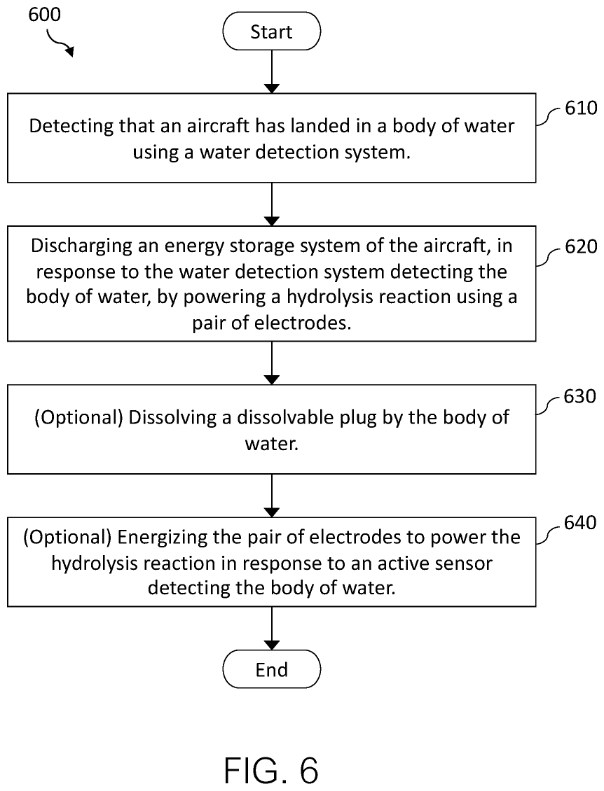

FIG. 6 is a flow diagram illustrating a method 600 for discharging an energy storage system of an aircraft. Method 600 can be performed by any of the EDSs described herein. Optionally, method 600 can be performed using a computing system (e.g., controller 130 in FIGS. 1A-2B, and/or 500 in FIG. 5). In step 610, an aquatic EDS detects that an aircraft (or portion thereof) (e.g., the portion of the aircraft 100 in FIG. 1A, 102 in FIG. 1B, or 106 in FIGS. 2A and 2B) has landed in a body of water using a water detection system. The water detection system can be passive (e.g., using a dissolvable plug such as 170 in FIG. 1A) or active (e.g., using a water contact sensor such as 135 in FIGS. 1A-2B, an accelerometer, or a shock sensor), as described herein. In step 620, an energy storage system of the aircraft is discharged, in response to the water detection system detecting the body of water, by powering a hydrolysis reaction using a pair of electrodes. The hydrolysis reaction converts water from the body of water into gases (e.g., hydrogen and oxygen).

Method 600 also includes optional steps 630 and 640. In optional step 630, a dissolvable plug (e.g., 170 in FIG. 1A) is dissolved by the body of water. Optional step 630 can be performed, for example, by a water detection system comprising a passive system comprising dissolvable plugs (e.g., as shown in FIGS. 1A and 1B). In such cases, the pair of electrodes can be isolated from the body of water by the dissolvable plugs before the dissolvable plugs dissolve, and can be submerged in the body of water after the dissolvable plugs are dissolved by the body of water. In optional step 640, the pair of electrodes is energized to power the hydrolysis reaction in response to an active sensor detecting the body of water. Optional step 640 can be performed, for example, by a water detection system comprising an active sensor that detects the presence of the body of water (e.g., as shown in FIGS. 1A-1B and 2A-2B). The detecting the body of water can be accomplished using a water contact sensor (e.g., 135 in FIGS. 1A-2B) to detect contact with water, or using an accelerometer or shock sensor to detect that the aircraft has experienced a water landing, as described herein. In some cases, optional step 640 can be performed using a computing system (e.g., controller 130 in FIGS. 1A-2B, and/or 500 in FIG. 5), wherein the computing system receives a signal from the sensor that water is present or that the vehicle has experienced a water landing and then energizes the pair of electrodes to power the hydrolysis reaction. In some cases, optional step 630 can be performed after step 620, and optional step 640 can be performed after optional step 630.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. An aquatic energy discharge system for an energy storage system of an aircraft, comprising:
an energy storage system;
a pair of electrodes coupled to the energy storage system; and
a water detection system configured to detect a water landing,
wherein the electrodes are configured to submerge in a body of water after the aircraft has landed in the body of water, and
wherein the electrodes are configured to cause a hydrolysis reaction that drains energy from the energy storage system in response to the water detection system detecting the water landing.

2. The aquatic energy discharge system of claim 1, wherein the water detection system comprises a water contact sensor configured to detect contact between the energy discharge system and water.

3. The aquatic energy discharge system of claim 1, wherein the water detection system comprises an accelerometer or a shock sensor configured to detect the water landing.

4. The aquatic energy discharge system of claim 1, wherein the water detection system comprises a passive system comprising a dissolvable plug, wherein the dissolvable plug is configured to isolate the pair of electrodes from the body of water before dissolving, and wherein the dissolvable plug is configured to expose the pair of electrodes to the body of water after dissolving.

5. The aquatic energy discharge system of claim 1, wherein the dissolvable plug comprises a salt or a polymer.

6. The aquatic energy discharge system of claim 1, wherein the energy storage system comprises a battery or a fuel cell.

7. The aquatic energy discharge system of claim 1, wherein the body of water is an ocean, lake, pond, reservoir, river, or stream.

8. The aquatic energy discharge system of claim 1, wherein the electrodes are configured to deliver energy to the body of water to cause the hydrolysis reaction.

9. A method of discharging an energy storage system of an aircraft, comprising:
detecting that an aircraft or a portion of an aircraft has landed in a body of water using a water detection system; and
discharging an energy storage system of the aircraft or portion of the aircraft, in response to the water detection system detecting that the aircraft or portion of the aircraft has landed in the body of water, by powering a hydrolysis reaction using a pair of electrodes, wherein the electrodes are coupled to the energy storage system and are submerged in the body of water.

10. The method of claim 9, wherein the detecting that the aircraft or portion of the aircraft has landed in the body of water using the water detection system comprises using a water contact sensor that detects the presence of the body of water, and
wherein the discharging the energy storage system of the aircraft or portion of the aircraft further comprises energizing the pair of electrodes to power the hydrolysis reaction in response to the active sensor detecting presence of the body of water.

11. The method of claim 9, wherein the detecting that the aircraft or portion of the aircraft has landed in the body of water using the water detection system comprises using an accelerometer or a shock sensor, and
wherein the discharging the energy storage system of the aircraft or portion of the aircraft further comprises energizing the pair of electrodes to power the hydrolysis reaction in response to the accelerometer or the shock sensor detecting that the aircraft or portion of the aircraft has landed in the body of water.

12. The method of claim 9, wherein detecting that the aircraft or portion of the aircraft has landed in the body of water using the water detection system comprises using a passive water detection system comprising dissolving the dissolvable plug by the body of water,
wherein the pair of electrodes are isolated from the body of water by the dissolvable plug before the dissolvable plug is dissolved, and
wherein the electrodes are submerged in the body of water after the dissolvable plug is dissolved by the body of water.

13. The method of claim 9, wherein the discharging the energy storage system comprises using a controller electrically coupled to the pair of electrodes and to the energy storage system to energize the pair of electrodes and control the hydrolysis reaction.

14. The method of claim 13, wherein the powering the hydrolysis reaction using the pair of electrodes further comprises controlling, using the controller, a voltage applied to the electrodes, including one or both of a magnitude and a duration of the applied voltage.

15. The method of claim 13, wherein the powering the hydrolysis reaction using the pair of electrodes further comprises controlling, using the controller, a current applied to the electrodes, including one or both of a magnitude and a duration of the applied current.

16. The method of claim 13, wherein the powering the hydrolysis reaction using the pair of electrodes further comprises controlling, using the controller, a total amount of charge drained from the energy storage system.

17. The method of claim 9, wherein the discharging the energy storage system is initiated within 2 minutes from a time when the aircraft makes contact with the body of water.

18. The method of claim 9, wherein the energy storage system comprises a battery or a fuel cell.

19. The method of claim 9, wherein the body of water comprises an ocean, a lake, a pond, a reservoir, a river, a stream, or portion thereof.
